(19) United States
(12) Patent Application Publication
(10) Pub. No.: US 2008/0254541 A1
(43) Pub. Date: Oct. 16, 2008

(54) Chip having microchannels and a method for continuous dilution of solution

(75) Inventors: Ji Yoon Kang, Seoul (KR); Choong Kim, Namyangju-si (KR); Kang Sun Lee, Incheon (KR); Sung Shin Ryu, Namyangju-si (KR); Tae Song Kim, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KOREA INSTITUTE OF SCIENCE AND TECHNOLOGY

(21) Appl. No.: 11/891,228

(22) Filed: Aug. 9, 2007

(30) Foreign Application Priority Data
Apr. 11, 2007 (KR) 10-2007-0035440

(51) Int. Cl. G01N 31/00; G01N 15/06

(52) U.S. Cl. 436/8; 422/68.1

(57) ABSTRACT

A microchannel chip and a dilution method using the same capable of continuously diluting the diverse concentrations of solution by one time fluid injection using the microfluid technology are provided. The microchannels are formed in a plastic chip using the microfluid technology, and a width, a sectional area, or a length of the microchannel is regulated so that the flow rate of a diluted solution (e.g., buffer solution) and a sample (e.g., chemicals or medicament) is controlled. The diluted solution and the specimen are mixed in the mixing channel according to the flow rate, thereby diluting the sample. Such a diluted solution is mixed again with a diluted solution, carrying out the dilution. With the repeated dilution processes, continuously diluted solution is obtained.

### BACKGROUND OF THE INVENTION

1. Field of the Invention

The present invention relates to a chip having microchannels and a method for continuously diluting the diverse ratios of a solution by one time fluid injection using the microfluid technology.

2. Description of the Prior Art

As generally known in the art, when purchasing a standard solution for use in a chemical/biological experiment or others, one would check whether the concentration unit of the standard solution is ug/ml or mg/kg. In case of the standard solution in ug/ml concentration unit, the solution is diluted using a pipet or a volumetric flask, and the standard solution in unit of mg/kg is diluted using a scale.

In order to prepare a solution diluted in diverse concentrations from a standard solution, a continuous dilution method has been developed. In the continuous dilution method, for example, 10 ml part is taken from the standard solution having the concentration of 1000 ug/ml, and diluted in 100 ml volumetric flask to prepare 100 ug/ml solution. Then, 10 ml part is taken from the solution in the volumetric flask, and diluted in another 100 ml volumetric flask, thereby preparing 10 ug/ml solution. Such processes are the generally used continuous dilution method. Such a method dilutes the concentration of a standard solution into the log scale concentration.

The method can dilute a standard solution in exponential form (e.g., 1/10, 1/100, 1/1000, 1/10000, . . . ).

Although the dilution method of a standard solution is not difficult, too many numbers of concentrations to be prepared make the preparation time for the desired concentration of solution prolonged, which thus tires the researchers. There is possibility that an error in concentration intended to obtain occurs depending upon the researcher's pipetting technology. In addition, in the process of diluting, the consumption of the volumetric flask also increases.

Accordingly, it needs to develop a solution dilution method and apparatus in order to solve such problems.

### SUMMARY OF THE INVENTION

Accordingly, the present invention has been made to solve the above-mentioned problems occurring in the prior art, and according to the present invention, microchannels are formed in a plastic chip using the microfluid technology, and a width, a sectional area, or a length of the microchannel is regulated so that the flow rate of a diluted solution (e.g., buffer solution) and a sample (e.g., chemicals or medicament) is controlled. The diluted solution and the specimen are mixed in the mixing channel according to the flow rate, thereby diluting the sample. Such a diluted solution is mixed again with a diluted solution, carrying out the dilution. With the repeated dilution processes, continuously diluted solution can be obtained.

Therefore, an object of the present invention is to provide a microchannel chip capable of continuously diluting the diverse concentrations of solution by one time fluid injection using the microfluid technology.

Another object of the present invention is to provide a method for continuously diluting the diverse concentrations of solution by one time fluid injection using the microfluid technology.

In accordance with an aspect of the present invention, there is provided a chip having microchannels for continuously diluting a sample, the chip comprising: a diluent inlet into which a diluent is injected; a first channel through which the diluent flows, the first channel being connected with the diluent inlet; a sample inlet into which a sample is injected; and a second channel through which the sample flows, the second channel being connected with the sample inlet. Here, the first channel includes a plurality of branch points from which the dilute diverges, the second channel includes a plurality of junction points into which the diluent flows, the plurality of branch points and junction points are connected in one-to-one with each other by branch channels, and an outflow channel through which a diluted solution, in which the sample is diluted by the diluent, flows out to outlets, is connected to the positions next to the respective junction points in the second channel.

In accordance with another aspect of the present invention, there is provided a method for continuously diluting a sample in a ratio of 1:n (n is the real number above 1) using the microchannel chip, the method comprising the steps of: (a) introducing a diluent into a first channel through a diluent inlet; (b) introducing the sample into a second channel through a sample inlet; and (c) obtaining a diluted solution through an outlet. Here, the ratio of the flow rate of the sample introduced into the second channel in the step (b) to the flow rate of the diluent introduced into the second channel through respective branch channels after introduced in the step (a) is 1:(n−1).

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing a concept of a microchannel chip according to the present invention;

FIG. 2 is a view showing the construction of the microchannels of the chip according to the present invention;

FIG. 3A is a perspective view of a lower substrate of the microchannel chip according to the present invention;

FIG. 3B is a perspective view of an upper substrate of the microchannel chip according to the present invention;

FIG. 3C is a perspective view of the tubing inserted into an inlet or an outlet of the microchannel chip according to the present invention;

FIG. 3D is a perspective view of the microchannel chip according to the present invention;

FIG. 3E is a plan view of the microchannel chip according to the present invention;

FIG. 3F is a sectional view of the microchannel chip according to the present invention;

FIG. 3G is a view of the structure of a mixing channel of the microchannel chip according to the present invention;

FIG. 4 is a view of the structure of the outlet of the microchannel chip according to the present invention;

FIG. 5A is a flow chart for explaining the procedure of diluting a solution using the microchannel chip according to the present invention;

FIG. 5B is a flow chart for explaining the procedure of culturing the cells in the diluted solution using the microchannel chip according to the present invention;

FIG. 6 is a photograph of a solution diluted using the microchannel chip according to the present invention; and

FIG. 7 is a graph showing the concentration ratio of the diluted solution relative to the flow rate thereof upon dilution using the microchannel chip according to an embodiment of the present invention.

### DETAILED DESCRIPTION OF THE EXEMPLARY EMBODIMENTS

Hereinafter, exemplary embodiments of a microchannel chip and a method of diluting a solution using the same according to the present invention will be described with reference to the accompanying drawings. The present invention however is not limited to the embodiments below. First, the microchannel chip for continuously diluting a sample will now be explained.

FIG. 1 is a conceptional diagram for explaining the principle of dilution by the microchannel chip according to an embodiment of the invention.

In FIG. 1, into a first inlet (buffer inlet) between two fluid inlets, a buffer solution (also referred to as a diluent) for diluting a chemical solution is injected, and into the other side-second inlet (chemical inlet), the chemical solution intended to dilute (sample) is injected. The buffer solution flowing through a first channel 1 diverges from respective branch points A1, A2, A3, and A4, flows through respective branch channels 3, and meets the chemical solution at respective junction points B1, B2, B3, and B4 in a second channel 2, thereby being mixed with the chemical solution.

Herein, the respective branch channels 3 through which the buffer solution flows while diverging from the branch points is designed such that the buffer solution flows in flowing ratio of 9 relative to the chemical solution (y1=y2=y3=y4=9). In addition, the second channel 2 through which the chemical solution flows is designed such that the chemical solution flows in flowing ratio of 1 relative to the buffer solution (x1=1). Thus, the buffer inlet of the first channel into which the buffer solution is introduced is designed such that the buffer solution flows in flow rate of 36 (9×4=36).

When the buffer solution flowing through the first channel 1 diverges from the first branch point A1, flows through the first branch channel 3, and meets and is mixed with the chemical solution at the first junction point B1 in the second channel 2, the chemical solution is diluted one tenth ( 1/10) times the initial concentration thereof (x1/(x1+y1)= 1/10). The total flow rate of the diluted solution is to be 10 (1 chemical solution+9 buffer solution). 9 of the flow rate flows out to the outlet C1 via an outflow channel 4. Thus, 1/10 times diluted solution can be obtained at the outlet C1.

Meanwhile, remaining 1 of the total flow rate of 10 of the diluted solution is mixed again with the buffer solution having the flow rate y2 of 9 at the second junction point B2, thereby being further diluted into 1/100 concentration ratio. Similarly, the total flow rate of the diluted solution is to be 10 (1 diluted solution+9 buffer solution). 9 of the flow rate flows out to the outlet C2 via an outflow channel 4. Thus, 1/100 times diluted solution can be obtained at the outlet C2.

Similarly, remaining 1 of the total flow rate of 10 of the diluted solution is mixed again with the buffer solution having the flow rate y3 of 9 at the third junction point B3, thereby being further diluted into 1/1000 concentration ratio.

In the process of such steps, the diluted solutions diluted with the chemical solution into 1/10, 1/100, 1/1000, and 1/10000 times the initial concentration can be obtained.

Like this, the microchannels can be configured such that the chemical solution is exponentially diluted by the regulation of the fluid resistances of the microchannels.

The flow rate of fluid flowing through the microchannels can be controlled by the regulation of the width, the sectional area, or the length of the microchannel in the microchannel chip and by the regulation of the pumping pressure applied to the fluid. Thus, with proper regulation of the ratio of the flow rate between the buffer solution and the chemical solution, the diluted solution having desired dilution ratio can be obtained.

In the embodiment, the flow rates y1, y2, y3, and y4 of the buffer solution introduced into the second channel 2 via the respective branch channels 3 are respectively configured to be identical to the respective flow rates of the diluted solution flowing out to the respective outflow channels 4 from the second channel 2, so that the diluted solutions flowing out via the respective outlets C1, C2, C3, and C4 are exponentially and continuously diluted.

In the present invention, however, when the flow rate of the buffer solution introduced into the second channel 2 via the respective branch channels 3, and the flow rate of a sample or a mixing solution introduced from the respective junction points B1, B2, B3, and B4 are properly selected so as to have proper flow rate flowing through the respective channels, the concentration of the diluted solution flowing out via the respective outlets C1, C2, C3, and C4 can be determined to a certain value.

For instance, in case where the sample x1 and the buffer solution y1 are introduced and mixed with each other at the first junction point B1, the concentration K1 of the diluted solution flowing out via the first outlet C1 is K1=x1/(x1+y1).

Then, at the second junction point B2, the diluted solution x2 that is the remaining solution after the certain amount of mixed solution x1+y1 flows out via the outflow channel 4, and the buffer solution y2 are introduced and mixed with each other. Thus, the concentration K2 of the diluted solution flowing out via the second outlet C2 is K2=K1·x2/(x2+y2).

Then, at the third junction point B3, the diluted solution x3 that is the remaining solution after the certain amount of mixed solution x2+y2 flows out via the outflow channel 4, and the buffer solution y3 are introduced and mixed with each other. Thus, the concentration K3 of the diluted solution flowing out via the third outlet C3 is K3=K2·x3/(x3+y3).

Similarly, the concentration K4 of the diluted solution flowing out via the fourth outlet C4 is K4=K3·x4/(x4+y4).

With the above principle, the flow rates of the respective channels allowing the diluted solution to be of the desired concentration can be calculated. Therefore, designing the microchannels to have the calculated flow rates, one can obtain the diluted solution with desired concentration ratio.

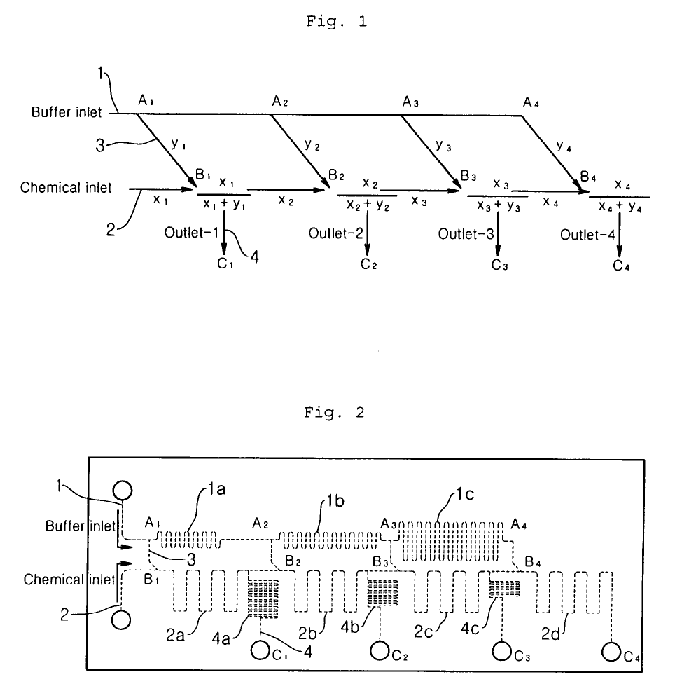

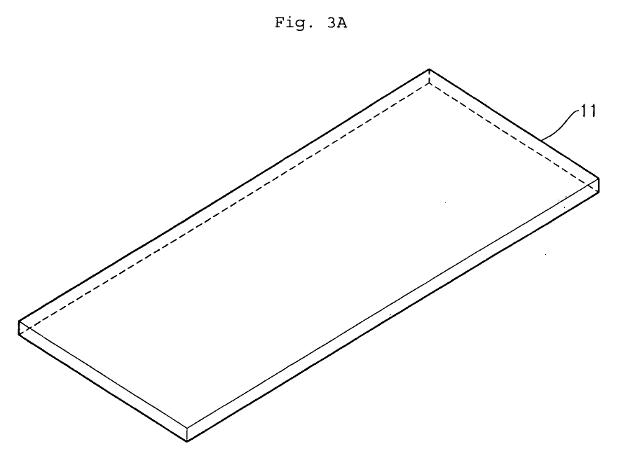

FIG. 2 illustrates the construction of the microchannels of the microchannel chip according to the present invention.

The microchannel chip comprises the diluent inlet (or buffer inlet) into which a diluent (or buffer) is injected, the first channel 1 through which the diluent flows, the first channel being connected with the diluent inlet, the sample inlet (or chemical inlet) into which a sample is injected, and the second channel 2 through which the sample flows, the second channel being connected with the sample inlet.

The first channel 1 includes a plurality of branch points A1, A2, A3, and A4 from which the dilute diverges, and the second channel 2 includes a plurality of junction points B1, B2, B3, ad B4 into which the diluent flows. The plurality of branch points A1, A2, A3, and A4 and junction points B1, B2, B3, and B4 are connected in one-to-one with each other by branch channels 3.

The outflow channels 4 through which a diluted solution, in which the sample is diluted by the diluent, flows out to the outlets C1, C2, C3, and C4, are connected to the positions next to the respective junction points B1, B2, B3, and B4 in the second channel 2.

The first channel, the second channel, and the outflow channel 4 each are preferably provided with folded channel units 1a, 1b, 1c, 2a, 2b, 2c, 2d, 4a, 4b, and 4c for maintaining constant fluid resistance of the respective passages through which the diluent, the sample, and the diluted solution (buffer solution) flow. For instance, the folded channel units 1a, 1b, and 1c are preferably provided between the branch points A1, A2, A3, and A4 of the first channel 1. The folded mixing channel units (i.e., folded mixing channels) 2a, 2b, 2c, and 2d are preferably provided between the junction points B1, B2, B3, and B4 of the second channel 2. In addition, the folded channel units 4a, 4b, and 4c are preferably provided in the outflow channels 4.

With the use of the above microchannel chip, a sample having certain concentration can be obtained.

Particularly, using the microchannel chip, a sample can be continuously diluted in the ratio of 1:n (n is the real number above 1). Hereinafter, description will be made of a method of continuously diluting a solution in the ratio of e.g., 1:10 using the above microchannel chip.

First, a buffer agent is introduced in the flow rate of 36 μl/min into the first channel 1 via the buffer inlet. In addition, a sample (initial concentration of the chemical solution is 1 μg/ml) is introduced in the flow rate of 1 μl/min into the second channel 2 via the chemical inlet.

Here, the buffer solution that has flown through the first channel flows through the four branch channels 3 in the same flow rate of 9 μl/min (i.e., y1=y2=y3=y4=9 μl/min), and then is introduced into the second channel 2. Herein, the flow rate (x1=x2=x3=x4) of the sample flowing through the second channel 2 is 1 μl/min, and the flow rate of the buffer agent introduced into the junction points B1, B2, B3, and B4 of the second channel 2 is 9 μl/min, so that the sample is diluted at the respective junction points B1, B2, B3, and B4.

For instance, since the chemical solution of x1=1 μg/min and the buffer agent of y1=9 μl/min are mixed at the first junction point B1, the concentration and the flow rate at that point of the chemical solution are 0.1 μg/ml and 10 μl/min, respectively. The diluted solution is completely mixed therewith during flowing through the mixing channel 2a. Then, the flow rate of 9 μl/min flows out to the first outlet C1 via the outflow channel 4, and the remaining diluted solution diluted into the concentration of 0.1 μg/ml flows through the second channel 2 in the flow rate of 1 μl/min.

Then, since the diluted solution of x2=1 μl/min and the buffer agent of y2=9 μl/min are mixed at the second junction point B2, the concentration and the flow rate at that point of the chemical solution are 0.01 μg/ml and 10 μl/min, respectively. The diluted solution is completely mixed therewith during flowing through the mixing channel 2b. Then, the flow rate of 9 μl/min flows out to the second outlet C2 via the outflow channel 4, and the remaining diluted solution diluted into the concentration of 0.01 μg/ml flows through the second channel 2 in the flow rate of 1 μl/min.

Through the processes, at the third outlet C3, the diluted solution diluted into the concentration of 0.001 μg/ml can be obtained, and at the fourth outlet C4, the diluted solution diluted into the concentration of 0.0001 μg/ml can be obtained.

At this time, only when the flow rate of the buffer agent introduced into the second channel 2 via the branch channels 3 and the flow rate of the diluted solution flowing out from the second channel 2 via the outflow channels 4 each are of the same value of 9 μl/min, the flow rate of the sample in the second channel 2 can be maintained at 1 μl/min. In order to make the flow rate of the diluted solution introduced into the second channel 2 via the respective branch channels 3 identical to the flow rate of the diluted solution flowing out from the second channel 2 via the outflow channels 4, the microchannel chip is preferably configured such that the sectional areas in width direction of the branch channels 3 and the outflow channels 4 are identical to each other.

Meanwhile, in case where the buffer agent is introduced into the buffer inlet, the flow rate is determined in consideration of the number of the branch channels and the flow rate of the buffer agent flowing through the branch channels. In the present embodiment, since the number of the branch channels is four, and the flow rate of the buffer agent flowing through the respective branch channels should be 9 μl/min, the buffer agent is forced to be introduced via the buffer inlet in the flow rate of 4×9 μl/min=36 μl/min.

Hereinafter, description will be made of the procedure of manufacturing the microchannel chip according to the present invention.

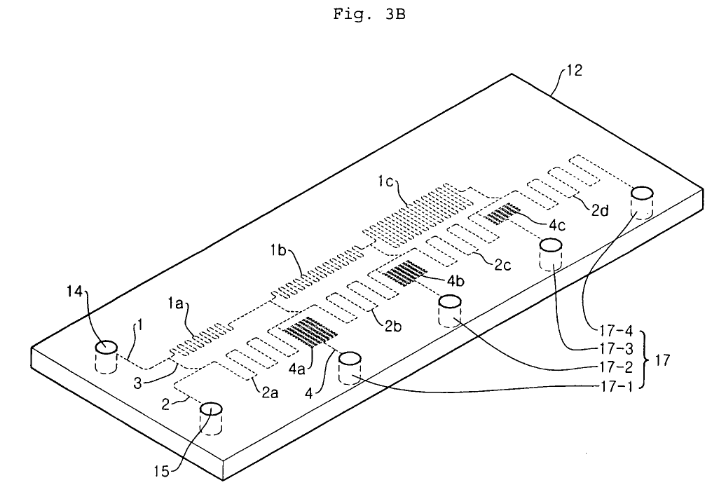

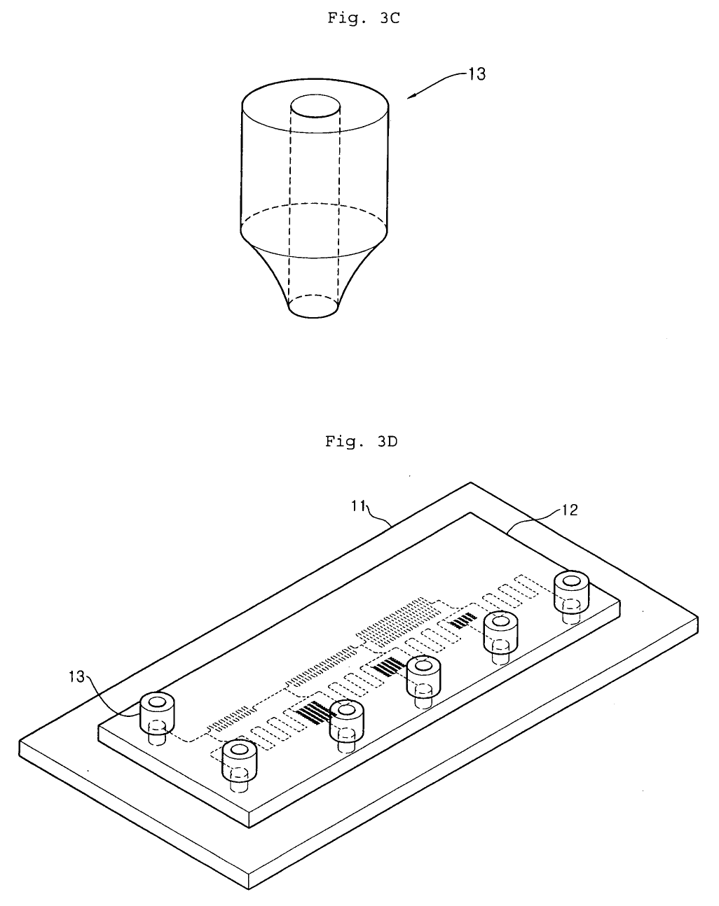

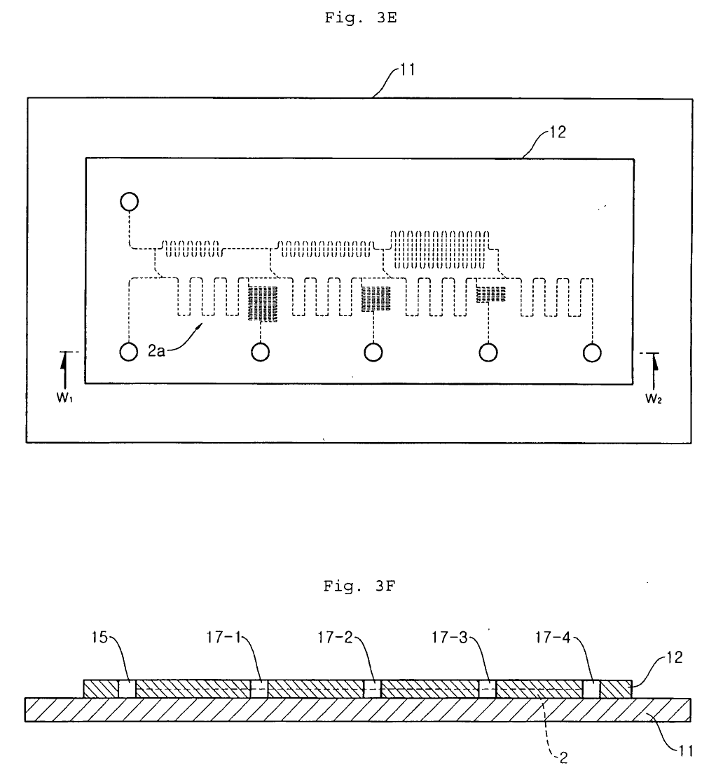

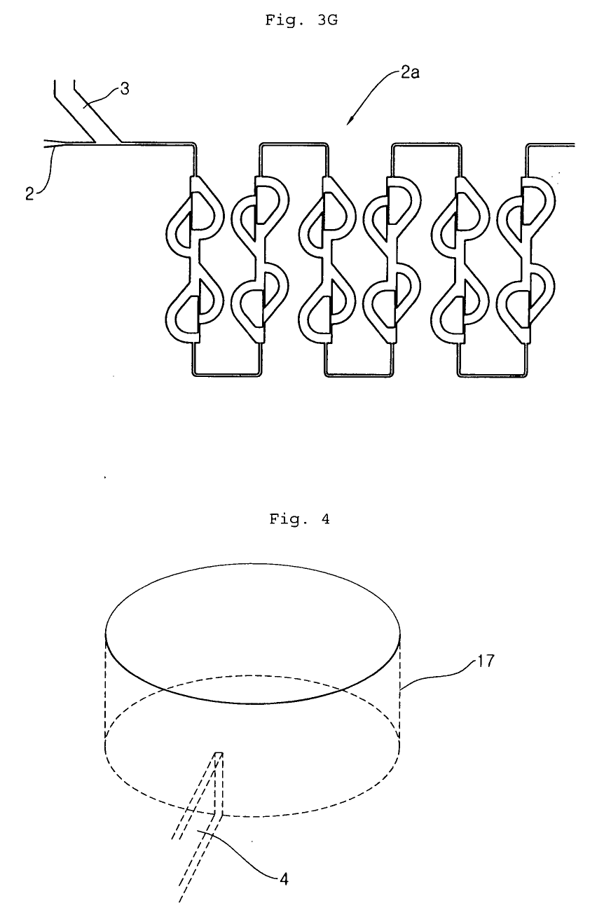

First, a lower substrate shown in FIG. 3A is prepared.

In addition, an upper substrate having the microchannels configured like FIG. 2 is prepared. The upper substrate may be prepared by forming a master having a pattern of the microchannels by photolithography and molding a plastic (e.g., PDMS) on the master.

The upper substrate includes a buffer inlet 14 through which the buffer agent is introduced, a sample inlet 15 through which a sample is introduced, and outlets 17-1 to 17-4 for flowing out the sample (diluted solution) diluted with the buffer agent, the inlets and the outlets being shaped like holes passing through the upper substrate.

FIG. 3C is a perspective view of the tubing 17 inserted into the inlet 14 and 15 or the outlet 17 of the microchannel chip according to the present invention. Through the tubing, a pump (not shown) can be connected so as to apply a pressure to allow fluids to be introduced through the inlet 14 and 15. Further, the diluted solution can be collected from the outlet 17 of the microchannel chip through the tubing.

FIG. 3D is a perspective view of the microchannel chip manufactured by joining the lower substrate of FIG. 3A and the upper substrate of FIG. 3B together, and connecting the tubing 13 with the inlets 14 and 15 and the outlets 17 of the upper substrate. FIG. 3E is a plan view of the microchannel chip, and FIG. 3F is a sectional view taken along line of W1-W2 of the microchannel chip.

FIG. 3G illustrates the structure of the mixing channel 2a of the microchannel chip in detail.

Through the above mixing channel 2a, the buffer agent (9 μl/min) and the chemical solution (1 μl/min) are completely mixed.

FIG. 4 is a view of the structure of the outlet 17 of the microchannel chip according to the invention. The outlet has a diameter of 2 mm, and is connected with the second channel 2 via the outflow channel 4. The outlet 17 can be utilized as space for culturing the cells in the diluted solution.

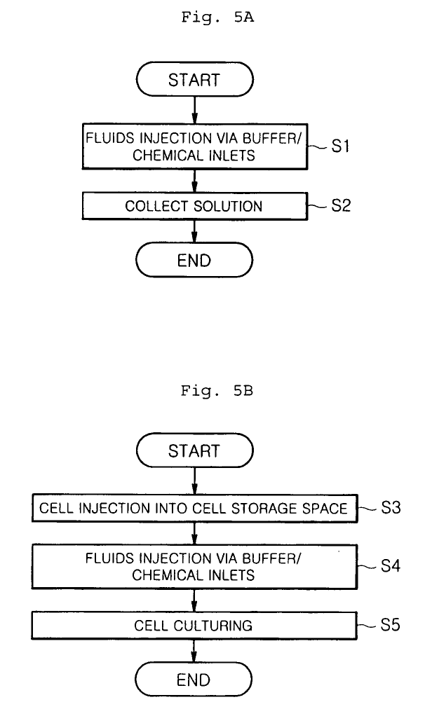

FIG. 5A is a flow chart for explaining the procedure of diluting a solution using the microchannel chip. First, the buffer solution and the chemical solution are injected through the respective inlets in the certain flow rates (S1). In this case, solutions diluted into certain concentrations flow out from the respective outlets, through which the solutions are collected (S2).

Meanwhile, it is possible to directly culture cells in the diluted solution diluted into certain concentration at the respective outlets using the microchannel chip. FIG. 5B is a flow chart for explaining the procedure of culturing the cells in the diluted solution using the microchannel chip. For culturing the cells like this, the cells are first injected into the respective cell culturing spaces 17 (S3), and the buffer solution and the chemical solution are injected through the respective inlets (S4). The cells are cultured in the cell culturing space 17 while the diluted solution continuously flows through the space as a culture solution (S5). During such cell culturing, cell behaviors, cytotoxicity, and cell differentiation are experimented.

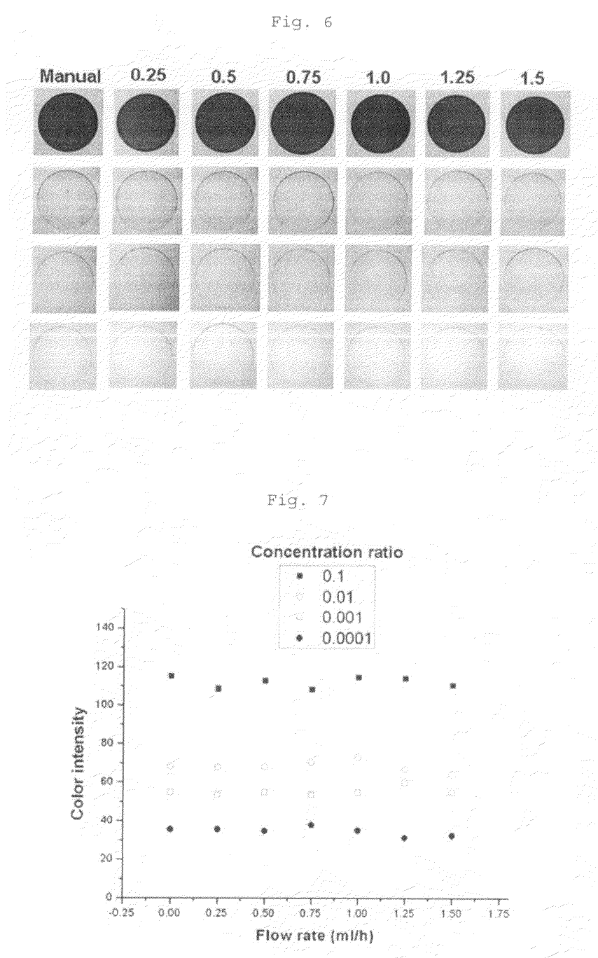

FIG. 6 is a photograph showing the concentrations of the diluted solutions actually diluted by the microchannel chip. The chemical solutions is diluted into the concentration of 0.1, 0.01, 0.001, and 0.0001, respectively. The utmost-left side solutions are the solutions that are manually prepared by pipetting, and the numbers denoted at the upper section are the flow rates (unit: μl/min) of the respective chemical solutions.

It can be seen that the diluted solutions diluted through the microchannel chip have the same colors as those obtained by common pipetting method. This means that in case of using the microchannel chip according to the present invention, the chemical solution can be diluted into desired concentration irrespective of the flow rates of the sample and the chemicals, and an error hardly occurs. That is, upon using the microchannel chip according to the present invention, there is no effect on variation in flow rate.

FIG. 7 is a graph showing the relation between the flow rate and the concentration of the diluted solution of FIG. 6 diluted using the microchannel chip. The analysis has been done using a Metlab program of an image process program in order to precisely analyze the images of FIG. 6. As an analysis result of color intensity, is can be seen that the concentrations of the diluted solutions obtained from the microchannel chip are substantially identical to those obtained from the common pipetting method.

Conventionally, in order to obtain many kinds of diluted solution samples, the users had to carry out manual pipetting, thereby requiring so much time and effort. However, in case of using the microchannel chip according to the present invention, with one time injection of the sample and the buffer solution, the diluted solutions having diverse concentrations can be continuously obtained.

Further, with utilization of the outlets as the cell culturing spaces, smooth signal transmission between cells is possible, and cell behaviors, cytotoxicity, and cell differentiation can be easily experimented. Furthermore, with the continuous supply of a cell culture solution, degradation by time in quality of the cell culture solution can be prevented, and the cells can be cultured in finer condition.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A chip having microchannels for continuously diluting a sample, the chip comprising:
a diluent inlet into which a diluent is injected;
a first channel through which the diluent flows, the first channel being connected with the diluent inlet;
a sample inlet into which a sample is injected; and
a second channel through which the sample flows, the second channel being connected with the sample inlet,
wherein the first channel includes a plurality of branch points from which the dilute diverges,
the second channel includes a plurality of junction points into which the diluent flows,
the plurality of branch points and junction points are connected in one-to-one with each other by branch channels, and
outflow channels through which a diluted solution, in which the sample is diluted by the diluent, flows out to outlets, are connected to the positions next to the respective junction points in the second channel.

2. The chip having the microchannels according to claim 1, wherein a folded channel unit is provided between the branch points of the first channel.

3. The chip having the microchannels according to claim 1, wherein a mixing channel is provided between the junction points of the second channel.

4. The chip having the microchannels according to claim 1, wherein a folded channel unit is provided at the outflow channel.

5. The chip having the microchannels according to claim 1, wherein
the respective branch channels and outflow channels have the same sectional areas in width direction such that the flow rates of the diluents introduced from the first channel into the second channel via the respective branch channels are the same, that the flow rates of the diluted solutions flowing out from the second channel to the respective outflow channels are the same, and that the flow rates of the diluents introduced into the second channel via the branch channels are the same as those of the diluted solutions flowing out from the second channel via the outflow channels.

6. A method of continuously diluting a sample in a ratio of 1:n (n is the real number above 1) using the chip having the microchannels according to claim 1, the method comprising the steps of:
(a) introducing the diluent into the first channel through the diluent inlet;
(b) introducing the sample into the second channel through the sample inlet; and
(c) obtaining the diluted solution through the outlet,
wherein the ratio of the flow rate of the sample introduced into the second channel in the step (b) to the flow rate of the diluent introduced into the second channel through the respective branch channels after introduced in the step (a) is 1:(n−1).

7. The method according to claim 6, wherein
when the number of the branch channels on the chip is k, the ratio of the flow rate of the sample introduced into the second channel in the step (b) relative to the flow rate of the diluent introduced into the first channel in the step (a) is 1:(n−1)k.

8. A method of continuously diluting a sample in a ratio of 1:n (n is the real number above 1) using the chip having the microchannels according to claim 2, the method comprising the steps of:
(a) introducing the diluent into the first channel through the diluent inlet;
(b) introducing the sample into the second channel through the sample inlet; and
(c) obtaining the diluted solution through the outlet,
wherein the ratio of the flow rate of the sample introduced into the second channel in the step (b) to the flow rate of the diluent introduced into the second channel through the respective branch channels after introduced in the step (a) is 1:(n−1).

9. The method according to claim 8, wherein
when the number of the branch channels on the chip is k, the ratio of the flow rate of the sample introduced into the second channel in the step (b) relative to the flow rate of the diluent introduced into the first channel in the step (a) is 1:(n−1)k.

10. A method of continuously diluting a sample in a ratio of 1:n (n is the real number above 1) using the chip having the microchannels according to claim 3, the method comprising the steps of:
(a) introducing the diluent into the first channel through the diluent inlet;
(b) introducing the sample into the second channel through the sample inlet; and
(c) obtaining the diluted solution through the outlet,
wherein the ratio of the flow rate of the sample introduced into the second channel in the step (b) to the flow rate of the diluent introduced into the second channel through the respective branch channels after introduced in the step (a) is 1:(n−1).

11. The method according to claim 10, wherein
when the number of the branch channels on the chip is k, the ratio of the flow rate of the sample introduced into the second channel in the step (b) relative to the flow rate of the diluent introduced into the first channel in the step (a) is 1:(n−1)k.

12. A method of continuously diluting a sample in a ratio of 1:n (n is the real number above 1) using the chip having the microchannels according to claim 4, the method comprising the steps of:
(a) introducing the diluent into the first channel through the diluent inlet;
(b) introducing the sample into the second channel through the sample inlet; and
(c) obtaining the diluted solution through the outlet,
wherein the ratio of the flow rate of the sample introduced into the second channel in the step (b) to the flow rate of the diluent introduced into the second channel through the respective branch channels after introduced in the step (a) is 1:(n−1).

13. The method according to claim 12, wherein
when the number of the branch channels on the chip is k, the ratio of the flow rate of the sample introduced into the second channel in the step (b) relative to the flow rate of the diluent introduced into the first channel in the step (a) is 1:(n−1)k.

14. A method of continuously diluting a sample in a ratio of 1:n (n is the real number above 1) using the chip having the microchannels according to claim 5, the method comprising the steps of:
(a) introducing the diluent into the first channel through the diluent inlet;
(b) introducing the sample into the second channel through the sample inlet; and
(c) obtaining the diluted solution through the outlet,
wherein the ratio of the flow rate of the sample introduced into the second channel in the step (b) to the flow rate of the diluent introduced into the second channel through the respective branch channels after introduced in the step (a) is 1:(n−1).

15. The method according to claim 14, wherein
when the number of the branch channels on the chip is k, the ratio of the flow rate of the sample introduced into the second channel in the step (b) relative to the flow rate of the diluent introduced into the first channel in the step (a) is 1:(n−1)k.
